(19) United States
(12) Patent Application Publication
(10) Pub. No.: US 2021/0233171 A1
(43) Pub. Date: Jul. 29, 2021

(54) COMPUTER METHOD AND APPARATUS FOR ADMINISTERING A COMMODITY MATERIAL TRANSACTION VIA A DISTRIBUTED LEDGER

(71) Applicant: ABAXX TECHNOLOGIES INC., Toronto (CA)

(72) Inventors: Joshua Crumb, Toronto (CA); Andrew Fedak, Toronto (CA); Christopher A. Wiklof, EVERETT, WA (US)

(21) Appl. No.: 17/166,994

(22) Filed: Feb. 3, 2021

Related U.S. Application Data
(63) Continuation-in-part of application No. PCT/US2019/045158, filed on Aug. 5, 2019.
Application No. PCT/US2019/045158 is a continuation-in-part of application No. PCT/US2019/045170, filed on Aug. 5, 2019.
(60) Provisional application No. 62/714,456, filed on Aug. 3, 2018.
(60) Provisional application No. 62/714,456, filed on Aug. 3, 2018.
(60) Provisional application No. 62/714,324, filed on Aug. 3, 2018.
(60) Provisional application No. 62/714,324, filed on Aug. 3, 2018.

(51) Int. Cl. G06Q 40/04; G06Q 20/36; G06Q 20/06; G06Q 30/06; H04L 9/06

(52) U.S. Cl. CPC G06Q 40/04; G06Q 20/3678; G06Q 20/0658; H04L 2209/38; G06Q 20/3674; H04L 9/0643; G06Q 30/0611

(57) ABSTRACT

A computer method for administering a commodity material transaction includes receiving a proof of ownership of a distinguishable instance of a commodity material, generating a smart contract representing ownership of the commodity material, issuing electronic tokens corresponding to ownership of the distinguishable instance of the commodity material, and transferring at least a portion of the electronic tokens to a first user wallet. The computer method may include receiving, via a first graphical user interface (GUI) from a seller, an ask price for a distinguishable instance of the commodity material, denominated in a first currency, and receiving, via a second GUI from a buyer, a bid price for the quantity of the commodity material, denominated in a second currency. The computer method includes determining that the ask price and the bid price meet a match criterion. The computer method includes receiving a first cryptocurrency transaction corresponding to the bid price from a buyer wallet into a transaction wallet, and transmitting a second cryptocurrency transaction corresponding to the ask price from the transaction wallet to a seller wallet. A computer system, method, and non-transitory medium provides for conveying value of a commodity using a distributed ledger.

### CROSS REFERENCE TO RELATED APPLICATIONS

The present application is a Continuation-in-Part Application that claims priority benefit from co-pending PCT Application No. PCT/US2019/045158, entitled “COMPUTER METHOD AND APPARATUS FOR ADMINISTERING A COMMODITY MATERIAL TRANSACTION VIA A DISTRIBUTED LEDGER”, filed Aug. 5, 2019 (docket number 3058-001-04) and PCT Application No. PCT/US2019/045170, entitled “METHOD AND APPARATUS FOR TOKENIZATION OF A NATURAL RESOURCE”, filed Aug. 5, 2019 (docket number 3058-011-04). PCT Applications No. PCT/US2019/045158 and PCT/US2019/045170, both claim priority benefit from U.S. Provisional Patent Application No. 62/714,456, entitled “COMPUTER METHOD AND APPARATUS FOR ADMINISTERING A COMMODITY MATERIAL TRANSACTION VIA A DISTRIBUTED LEDGER,” filed Aug. 3, 2018 (docket number 3058-001-02), now expired; and from U.S. Provisional Patent Application No. 62/714,324, entitled “METHOD AND APPARATUS FOR CONVEYING VALUE ASSOCIATED WITH A COMMODITY,” filed Aug. 3, 2018 (docket number 3058-002-02), now expired. Each of the foregoing applications, to the extent not inconsistent with the disclosure herein, is incorporated by reference.

### SUMMARY OF THE DISCLOSURE

According to an embodiment, a computer method for administering a commodity material transaction includes receiving, via a first graphical user interface (GUI) from a seller, an ask price for a quantity of a commodity material, denominated in a first currency, and receiving, via a second GUI from a buyer, a bid price for the quantity of the commodity material, denominated in a second currency. The computer method includes determining that the ask price and the bid price meet a match criterion. The computer method includes receiving a first digital currency, cryptocurrency, or digital security transaction corresponding to the bid price from a buyer electronic wallet into a transaction electronic wallet, and transmitting a second digital currency, cryptocurrency, or digital security transaction corresponding to the ask price from the transaction electronic wallet to a seller electronic wallet. The computer method includes issuing a distributed ledger token corresponding to the quantity of the commodity material, and transmitting the distributed ledger token to the buyer electronic wallet.

According to an embodiment, a non-transitory computer-readable medium carries computer instructions to cause a computer to execute a method including receiving, via a first graphical user interface (GUI) from a seller, an ask price for a quantity of a commodity material, denominated in a first currency, and receiving, via a second GUI from a buyer, a bid price for the quantity of the commodity material, denominated in a second currency. The non-transitory computer-readable medium includes determining that the ask price and the bid price meet a match criterion. The non-transitory computer-readable medium includes receiving a first cryptocurrency, digital security financial instrument, and/or digital bearer asset transaction corresponding to the bid price from a buyer electronic wallet into a transaction electronic wallet, and transmitting a second digital financial instrument, or digital bearer asset, cryptocurrency, and/or digital security transaction corresponding to the ask price from the transaction electronic wallet to a seller electronic wallet. The non-transitory computer-readable medium includes issuing a distributed ledger token corresponding to the quantity of the commodity material, and transmitting the distributed ledger token to the buyer electronic wallet.

According to an embodiment, a computer system includes a webserver configured to output a first graphical user interface (GUI) to a first device for a seller and to receive an ask price for a quantity of a commodity material. The webserver is further configured to output a second GUI to a second device for a buyer and to receive a bid price for the quantity of the commodity material. The computer system includes a server computer, operatively coupled to the webserver, and configured to determine that the ask price and the bid price meet a match criterion, to authorize first and second cryptocurrency and/or digitally securitized asset transactions to respectively transfer the ask price to the seller and receive the bid price from the buyer, and to transmit said authorizations to the webserver.

According to an embodiment, a computer method for conveying value associated with a commodity includes issuing, with a server computer, a distributed ledger token corresponding to a distinguishable instance of a commodity, and outputting, with a web server for display via a graphical user interface (GUI) on a user device, information corresponding to the distributed ledger token and the distinguishable instance of the commodity. The distributed ledger token represents ownership of the distinguishable instance of the commodity.

According to an embodiment, a non-transitory computer readable medium carrying computer instructions capable of causing a computer to execute a method including issuing, with a server computer, a distributed ledger token corresponding to a distinguishable instance of a commodity, and outputting, with a web server for display via a graphical user interface (GUI) on a user device, information corresponding to the distributed ledger token and the distinguishable instance of the commodity. The distributed ledger token represents ownership of the distinguishable instance of the commodity.

According to an embodiment, a computer system for conveying value associated with a commodity includes a web server operatively coupled to a first user device via the Internet. The web server is configured to receive commodity availability data from the first user device. The computer system includes at least one server computer operatively coupled to the web server. The server computer is configured to receive the commodity availability data from the web server and issue a distributed ledger token corresponding to a distinguishable instance of the available commodity. The server computer is further configured to credit the distributed ledger token to the first user in return for a smart contract that causes ownership of the distributed ledger token to legally represent ownership of the commodity distinguishable instance. The server computer is further configured to cooperate with the web server to transmit information related to the distributed ledger token and the commodity distinguishable instance represented thereby, via the Internet, for display in a graphical user interface (GUI) on the user device.

According to an embodiment, a computer method for transferring an interest in a commodity includes receiving, into a server computer from a first user via a graphical user interface (GUI) displayed on a remote user device and a network, a private key and an image of a proof of ownership of a distinguishable instance of a commodity. The computer method includes generating a smart contract conveying conditional ownership of the distinguishable instance of the commodity. The computer method includes issuing, with the server computer, a first quantity of electronic tokens on a distributed ledger, the first quantity of electronic tokens carrying the smart contract such that the first quantity of electronic tokens are capable of collectively representing ownership of the distinguishable instance of the commodity. The computer method includes transferring at least a portion of the first quantity of electronic tokens to a first user electronic wallet corresponding to the first user, and receiving, from the first user via a remote device, an offer to sell at least a portion of the first quantity of electronic tokens. The computer method includes listing at least a portion of the first quantity of electronic tokens on an electronic token exchange, and transferring at least a portion of the first quantity of electronic tokens from the first user electronic wallet to a buyer electronic wallet using an exchange settlement service disposed on a second server computer.

According to an embodiment, a computer method for obtaining rights to a commodity material includes displaying to a commodity rights buyer via a first graphical user interface (GUI), data indicating availability of the quantity of a commodity material and an ask price for the available quantity, denominated in a first currency. The computer method includes receiving, from the buyer via the GUI, a bid price for the quantity of the commodity material, denominated in a second currency. The computer method includes receiving, from a server computer via the GUI, an indication of whether or not the bid price and the ask price meet a match criterion. If the bid price and the ask price are indicated as meeting the match criterion, the computer method includes transmitting to the server computer, a first cryptographic currency transaction to transfer an amount of cryptographic currency corresponding to the bid price from a buyer electronic wallet into a transaction electronic wallet. The computer method includes receiving and displaying a notice that a distributed ledger token corresponding to the quantity of the commodity material is transferred to the buyer electronic wallet.

According to an embodiment a computer method for conveying rights to a commodity material includes receiving from a commodity rights seller via a first graphical user interface (GUI), an availability of a quantity of the commodity material. The computer method includes receiving, from the seller via the first GUI, an ask price for rights corresponding to the quantity of the commodity material, denominated in a first currency. The computer method further includes receiving from a server computer a bid price for the quantity of the commodity material, denominated in a second currency. The computer method includes receiving, from the server computer, an indication of whether or not the bid price and the ask price meet a match criterion. If the bid price and the ask price are indicated as meeting the match criterion, the computer method includes receiving and displaying a notice that an amount of the cryptographic currency corresponding to the ask price is transferred to a seller electronic wallet. The computer method further includes receiving and displaying a notice that a non-fungible distributed ledger token corresponding to the available quantity of commodity material is transferred out of the seller electronic wallet.

### BRIEF DESCRIPTION OF THE DRAWINGS

FIG. 1 is a flowchart showing a computer method for administering a commodity material transaction, according to an embodiment.

FIG. 2 is a block diagram of a computer system configured to administer a commodity material transaction, according to an embodiment.

FIG. 3 is a flowchart illustrating a computer method for conveying value associated with a commodity, according to an embodiment.

FIG. 4 is a flowchart illustrating a process of the method shown in FIG. 3, according to an embodiment.

FIG. 5 is a diagram of a computer system for conveying value associated with a commodity, according to an embodiment.

FIG. 6 is a flowchart showing a computer method for transferring an interest in a commodity, according to an embodiment.

FIG. 7 is a flowchart for a computer method for obtaining rights to a commodity material, according to an embodiment.

FIG. 8 is a flowchart for a computer method for conveying rights to a commodity material, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

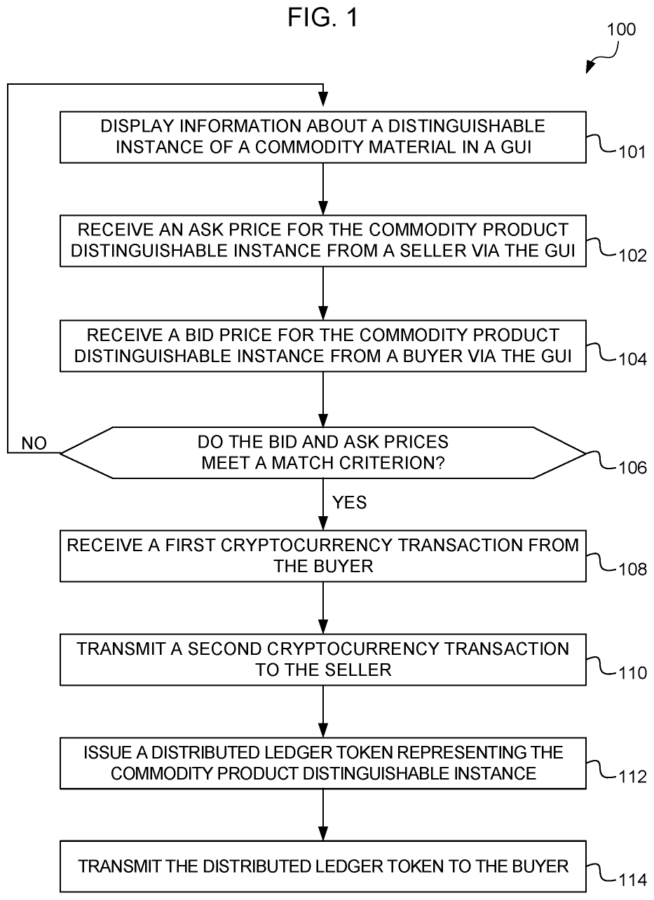

FIG. 1 is a flowchart showing a computer method 100 for administering a commodity material transaction, according to an embodiment. The computer method 100 may include several steps.

According to an embodiment, step 102 may include receiving, via a first graphical user interface (GUI) from a seller, an ask price for a quantity of a commodity material, denominated in a first currency.

According to an embodiment, step 104 may include receiving, via a second GUI from a buyer, a bid price for the quantity of the commodity material, denominated in a second currency.

According to an embodiment, step 106 may include determining whether or not the ask price and the bid price meet a match criterion. For example, according to an embodiment, if the bid price is greater than or equal to the ask price, it may be determined that the match criterion is met. In another embodiment, the match criterion may be determined as being met if the bid price is greater than a predetermined threshold amount below the ask price.

According to an embodiment, if it is determined, in step 106, that the ask price and the bid price meet the match criterion, step 108 may include receiving a first digital bearer asset, cryptocurrency and/or digitally securitized asset transaction corresponding to the bid price from a buyer electronic wallet into a transaction electronic wallet.

According to an embodiment, step 110 may include transmitting a second digital bearer asset, cryptocurrency, and/or digitally securitized asset transaction corresponding to the ask price from the transaction electronic wallet to a seller electronic wallet.

According to an embodiment, step 112 may include issuing a distributed ledger token corresponding to the quantity of the commodity material.

According to an embodiment, step 114 may include transmitting the distributed ledger token to the buyer electronic wallet.

According to an embodiment, with reference to step 104, the first currency may include a fiat currency such as United States dollars. Additionally or alternatively, the first currency may include a cryptocurrency, digital security, and/or digital bearer asset. According to an embodiment, the second currency may include a different currency than the first currency. According to an embodiment, when the second currency is different from the first currency, a calculated or predetermined exchange rate may be applied. According to an embodiment, the second currency may include the same currency as the first currency.

According to an embodiment, the first GUI in step 102 and the second GUI in step 104 may include respective instances of the same GUI.

According to an embodiment, referring to FIG. 1, step 101 may include displaying, via the GUI to at least one of the seller or the buyer, information about a distinguishable instance of a commodity material. For example, step 201 may include displaying at least one benchmark price for the quantity of the commodity material. Additionally or alternatively, step 101 may include displaying, via the GUI to at least one of the seller or the buyer, at least one estimated price for the quantity of the commodity material. In another embodiment, step 101 may include displaying, via the GUI to at least one of the seller or the buyer, at least one historical price for the quantity of the commodity material. In another embodiment, step 101 may include displaying a currency exchange rate for accepted transaction currencies. In some implementations the currency exchange rate(s) may be a parameter provided in or with a token representing a quantity or value of the commodity material.

According to an embodiment, with reference to step 106, determining that the ask price and the bid price meet a match criterion may include determining that the bid price is greater than or equal to the ask price plus a transaction fee.

According to an embodiment, if the ask price and the bid price do not match a criterion, the process may return to step 101, displaying, via the GUI, the benchmark price for the quantity of the commodity material.

According to an embodiment, with reference to step 108, receiving the first cryptocurrency, digital security, and/or digital bearer asset transaction from the buyer electronic wallet into the transaction electronic wallet may include receiving a fungible cryptocurrency and/or a digitally securitized asset. Additionally or alternatively, with reference to step 108, receiving the first cryptocurrency, digital security and/or digital bearer asset transaction may include receiving a distributed ledger token corresponding to a quantity of a second commodity material different than the commodity material.

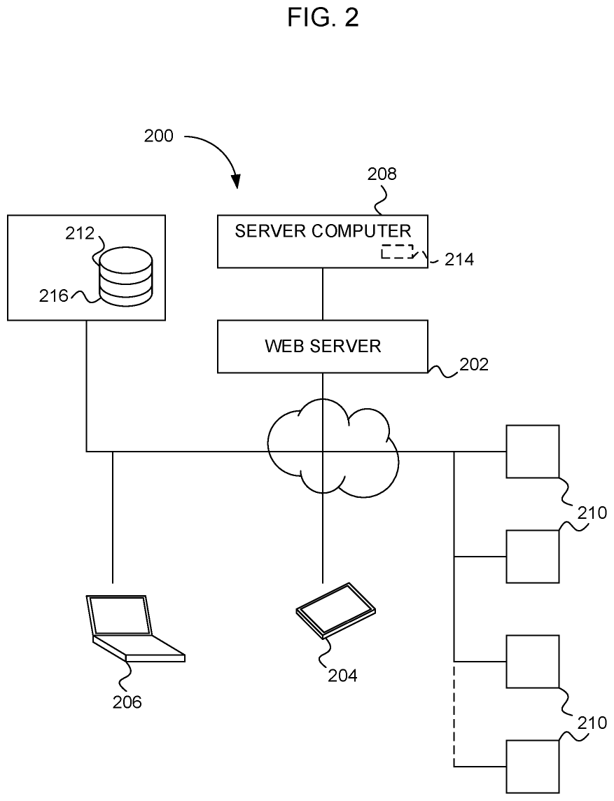

According to an embodiment, step 101 may include displaying a property of the commodity material in the GUI. In embodiments, the property may include a commodity grade, a physical property, an extrinsic property, an elemental analysis, and/or other properties that may affect a value of the commodity material. Additionally or alternatively, step 101 may include displaying price information about the commodity quantity in the GUI. According to an embodiment, with reference to step 101, displaying the price information may include displaying a price history for previous quantities of the commodity material. Additionally or alternatively, with reference to step 101, displaying the price information may include displaying a modeled price for the commodity material. Compared with a predetermined price or a most recent transaction on a token, a modeled price is an expected price calculated based on one or more parameters over time. For example, according to an embodiment, a modeled price may be extrapolated based on one or more of a trend over a predetermined past period (e.g., moving 20-day average) and/or a predetermined number of past transactions (e.g., last 5, 10, or 50 transactions). According to an embodiment, the modeled price may be based on audit feedback for the subject commodity locally, regionally, or globally. For example, a server computer (e.g., 208 in FIG. 2) may obtain information regarding the commodity with respect to transportation losses and/or storage losses, and may thus calculate a modeled price based on the losses. In another example, the server computer may obtain information from a value-add process or processor that may affect the modeled price. For example, assay results of an ore warrant a change in price, or a refining of the commodity, or discovery of a new commodity source or processing technique may be used to calculate the modeled price. In some embodiments the model price may be calculated by an artificial intelligence (Al) or machine learning algorithm configured to accept one or more inputs discussed above to calculate a model price.

According to an embodiment, with reference to step 102, the quantity of commodity material may include a particular distinguishable instance of the commodity material and/or may include a generalized or fungible portion of the commodity.

According to an embodiment, the commodity material may include in-situ minerals, metals, and hydrocarbon deposits. According to an embodiment, the quantity may include a ton or a metric tonne. According to an embodiment, the quantity may include a quantity of refined metal produced from the in-ground ore.

According to an embodiment, the commodity material may be produced (e.g., mined, harvested, butchered, refined, etc.) at a future date. According to an embodiment, the commodity material may exist in a transportable form at the moment of distributed ledger token issuance.

According to an embodiment, the commodity material may include mined ore or coal. Additionally or alternatively, the commodity material may include hydrocarbon deposits including oil and/or natural gas. In an alternative embodiment, the commodity material may include liquefied natural gas.

According to an embodiment, the quantity may include a number of standard cubic feet. Additionally or alternatively, the quantity may include a unit of mass. In an alternative embodiment, the quantity may include a unit of energy.

According to an embodiment, the commodity material may include a (e.g., an in-ground) portion of a natural gas deposit. Additionally or alternatively, the commodity material may include an agricultural product.

According to an embodiment, step 112 may further include receiving a second ask price for the distributed ledger token at a later date. The distributed ledger token may represent the same distinguishable instance of the commodity material as when the distributed ledger token was issued, according to an embodiment.

According to an embodiment, the method 100 may include receiving notice that the distinguishable instance of the commodity material is delivered, receiving payment for the delivered commodity material, and redeeming the distributed ledger token for a currency corresponding to the received payment.

According to an embodiment, the distributed ledger token may be burned when redeemed. “Burning” the distributed ledger token refers to rendering the token permanently non-tradable. According to an embodiment, the value of the distributed ledger token may be reset to zero when redeemed. Additionally or alternatively, the value of the distributed ledger token may be set to equal the current value of the quantity of the commodity material. According to an embodiment, the distributed ledger token may be asset-backed by the distinguishable instance of commodity material it is issued to represent.

According to an embodiment, a non-transitory computer-readable medium may be configured to store and permit processor access to computer instructions to cause a computer to execute the method 100 described above, including at least steps 102 through 114.

FIG. 2 is a block diagram of a computer system 200 configured to administer a commodity material transaction, according to an embodiment.

According to an embodiment, the computer system 200 may include a webserver 202 configured to output a first graphical user interface (GUI) to a first device 204 for a seller and to receive an ask price for a quantity of a commodity material. The webserver 202 may be further configured to output a second GUI to a second device 206 for a buyer and to receive a bid price for the quantity of the commodity material, according to an embodiment. The computer system 200 may include a server computer 208, operatively coupled to the webserver 202, and configured to determine that the ask price and the bid price meet a match criterion, to authorize first and second cryptocurrency and/or digitally securitized asset transactions to respectively transfer a currency amount or token value corresponding to the ask price to the seller and receive a currency amount or token value corresponding to the bid price from the buyer, and transmit said authorizations to the webserver 202.

According to an embodiment, the computer system 200 may include a plurality of devices 210 operatively coupled to the webserver 202 and carrying the distributed ledger. The webserver 202 may be configured to transmit the authorized first and second cryptocurrency and/or digitally securitized asset transactions to the plurality of devices 210, according to an embodiment. The plurality of devices 210 may be configured to collectively validate the first and second cryptocurrency and/or digitally securitized asset transactions, according to an embodiment. The webserver 202 may be configured to receive and forward collective validation to the server computer 208, according to an embodiment.

According to an embodiment, the server computer 208 may be further configured to receive a first cryptocurrency and/or digitally securitized asset transaction corresponding to the bid price from a buyer electronic wallet 212 to a transaction electronic wallet 214 via the webserver 202. The server computer 208 may transmit a second cryptocurrency and/or digitally securitized asset transaction corresponding to the ask price from the transaction electronic wallet 214 to a seller electronic wallet 216 via the webserver 202, according to an embodiment. The server computer 208 may issue a distributed ledger token corresponding to the quantity of the commodity material, according to an embodiment. The server computer 208 may cause the webserver 202 to transmit the token to the buyer electronic wallet 212.

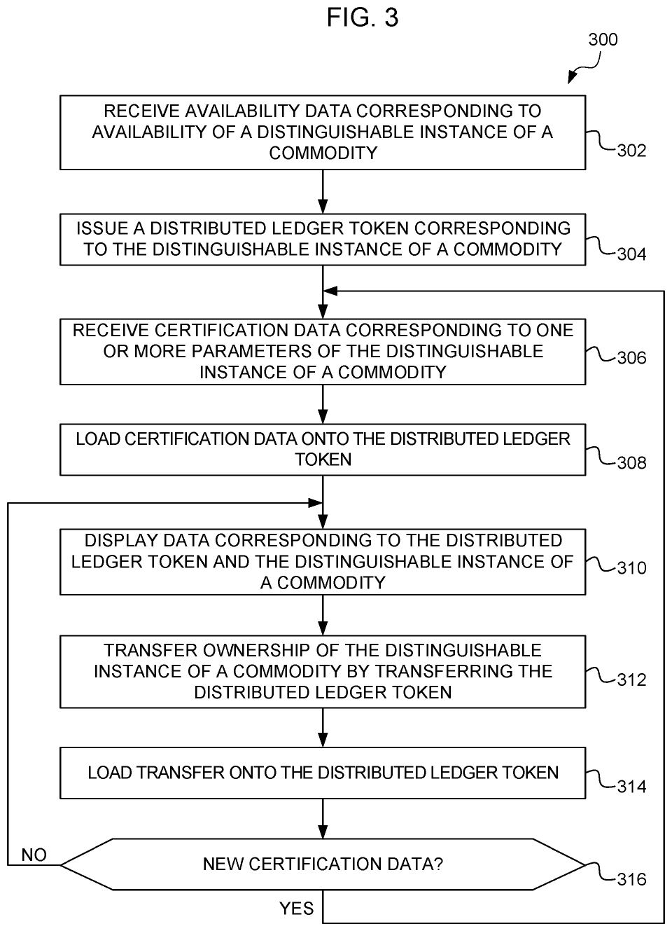

FIG. 3 is a flowchart illustrating a computer method 300 for conveying value associated with a commodity, according to an embodiment. While FIG. 3 illustrates steps 302 through 316, it will be acknowledged, by those having skill in the art, that the illustrated operations may include additional details, some of which are discussed below, additional steps between or alternative to those illustrated, and/or that some of the illustrated operations may be excluded in an embodiment. The computer method 300 may include several steps.

According to an embodiment, step 304 may include issuing, with a server computer, a distributed ledger token corresponding to a distinguishable instance of a commodity.

According to an embodiment, step 310 may include outputting, with a web server for display via a graphical user interface (GUI) on a user device, information corresponding to the distributed ledger token and the distinguishable instance of the commodity.

According to an embodiment, with reference to step 304, the distributed ledger token represents ownership of the distinguishable instance of the commodity and/or may represent full or partial rights to access, acquire, transfer ownership of, waste, consume, transform, and/or combine with other commodity instances.

According to various embodiments, the distinguishable instances of the commodity may have 1:1 relationships to respective distributed ledger tokens. For example, the nth distinguishable instance transferred during receipt for shipment, an intermodal transfer, or delivery, etc., may correspond specifically to the nth token. In this way, in the case of distinguishable instances being defined according to sequence, lower sequenced tokens have a higher probability of delivery in a lossy transport system.

In another embodiment, the distributed ledger tokens and respective distinguishable instances may have a many-to-many relationship, within a commodity distinguishable instances set (e.g., within a particular day of issuance, production, or shipment). In this way, all distributed ledger tokens in an issued set have an equal probability of delivery in a lossy transport system.

The relationship of distinguishable instances to distributed ledger tokens in a given issuance may optionally be selectable as a parameter by the seller or the token issuer.

According to an embodiment, referring to FIG. 3, step 302 may include receiving, via the web server, availability data from a seller device indicating availability of the distinguishable instance of the commodity. According to an embodiment, with reference to step 302, the availability data may be indicative of current availability of the distinguishable instance of the commodity. Additionally or alternatively, the availability data may be indicative of a planned availability of the commodity. According to an embodiment, receiving the availability data, in step 302, may include receiving the data as an encrypted transaction on the distributed ledger.

According to an embodiment, with reference to step 304, issuing the distributed ledger token may include issuing a public blockchain token. Additionally or alternatively, issuing the distributed ledger token may include issuing a permissioned blockchain token. In another embodiment, issuing the distributed ledger token may include issuing a private blockchain token.

According to an embodiment, with reference to step 304, issuing the distributed ledger token corresponding to the distinguishable instance of the commodity may include parsing property data related to one or more physical properties of the distinguishable instance of the commodity, hashing the property data, and adding the property data onto the distributed ledger as a transaction. In another embodiment, issuing the distributed ledger token corresponding to the distinguishable instance of the commodity may include, in step 304, receiving property data from a seller device, the data corresponding to the one or more physical properties.

According to an embodiment, with reference to step 304, issuing the distributed ledger token corresponding to the distinguishable instance of the commodity may include parsing property data related to a mass or volume of the distinguishable instance of the commodity, hashing the property data, and adding the property data onto the distributed ledger as a transaction. In another embodiment, issuing the distributed ledger token corresponding to the distinguishable instance of the commodity may include, in step 304, receiving property data from a seller device, the data corresponding to the one or more physical properties.

According to an embodiment, with reference to step 304, issuing the distributed ledger token corresponding to the distinguishable instance of the commodity may include parsing availability data related to a projected date or time of availability of the distinguishable instance of the commodity, hashing the availability data, and adding the availability data onto the distributed ledger as a transaction. In another embodiment, issuing the distributed ledger token corresponding to the distinguishable instance of the commodity may include, in step 304, receiving availability data from a seller device, the data corresponding to the one or more physical properties.

According to an embodiment, with reference to step 304, issuing the distributed ledger token corresponding to the distinguishable instance of the commodity may include parsing availability data related to a location of the distinguishable instance of the commodity, hashing the availability data, and adding the availability data onto the distributed ledger as a transaction. In another embodiment, issuing the distributed ledger token corresponding to the distinguishable instance of the commodity may include, in step 304, receiving availability data from a seller device, the data corresponding to the one or more physical properties.

According to an embodiment, with reference to step 304, issuing the distributed ledger token corresponding to the distinguishable instance of the commodity may include parsing availability data related to a position of the distinguishable instance of the commodity in a sequence of distinguishable instances of the commodity, hashing the availability data, and adding the availability data onto the distributed ledger as a transaction. In another embodiment, issuing the distributed ledger token corresponding to the distinguishable instance of the commodity may include, in step 304, receiving availability data from a seller device, the data corresponding to the one or more physical properties.

According to an embodiment, referring to FIG. 3, step 306 may include receiving, via the web server, certification data corresponding to a certification of one or more parameters corresponding to the distinguishable instance of the commodity. According to an embodiment, receiving certification data corresponding to the certification of one or more parameters corresponding to the distinguishable instance of the commodity may include receiving certification data from the seller, as in a self-certification. Additionally or alternatively, receiving certification data corresponding to the certification of one or more parameters corresponding to the distinguishable instance of the commodity may include receiving data from a third party, as in a registered certification agent. In another embodiment, receiving certification data corresponding to the certification of one or more parameters corresponding to the distinguishable instance of the commodity may include receiving data from an automated measurement device, as in machine certification.

According to an embodiment, step 308 may include adding the certification data corresponding to the certification of one or more parameters corresponding to the distinguishable instance of the commodity onto the distributed ledger token. According to an embodiment, with reference to step 308, the certification data may be added onto the distributed ledger token as metadata. Additionally or alternatively, the certification data may be added onto the distributed ledger token as an encrypted transaction. In an embodiment, the certification data may be added onto the distributed ledger token at the moment of issuance. Additionally or alternatively, the certification data may be added onto the distributed ledger token after issuance of the distributed ledger token.

According to an embodiment, referring to FIG. 3, the computer method 300 may include establishing at least a first value after adding the certification data onto the distributed ledger token.

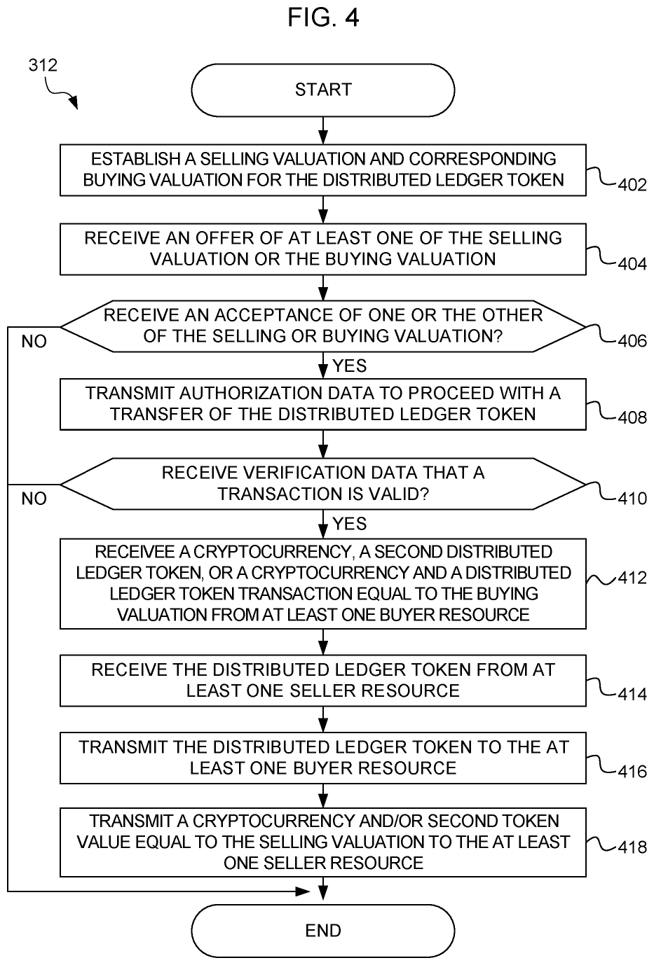

According to an embodiment, the computer method 300 may include a process 312 to transfer ownership of the distributed ledger token from a seller to a buyer. The process 312 may include several steps, as discussed below with reference to FIG. 4. According to an embodiment, transferring ownership of the distributed ledger token may also transfer ownership of the distinguishable instance of the commodity corresponding to the distributed ledger token.

According to an embodiment, the computer method 300 may include a determination step 316 to determine if new certification data is available. If no certification data is available, the computer method 300 may return to step 310. If new certification data is available, the computer method 300 may return to step 306 described above.

FIG. 4 is a flowchart illustrating the process 312 of the computer method 300 shown in FIG. 3, according to an embodiment.

According to an embodiment, with reference to the process 312 in FIG. 4, transferring ownership of the distributed ledger token may include, in step 402, establishing, using at least the server computer, a selling valuation and a corresponding buying valuation for the distributed ledger token. For example, step 402 may include receiving a selling price (or “ask price”) from the seller. Alternatively, establishing the selling valuation may include calculating the selling valuation from one or more offered buying prices. In embodiments, a difference between buying price and selling valuation corresponds to an exchange fee for a transaction. In embodiments, establishing the selling valuation may include calculating the selling valuation based on one or more of: historical sale valuations; a seller-proposed selling price; a predetermined markup amount; a commodity index value; a local, regional or global demand surge or decline; a local, regional, or global supply surge or decline; costs such as government fees (e.g., taxes), salesperson or broker commissions, value-add services (transportation, assay, refining, storage, etc.); or a selling valuation change of a related commodity.

According to an embodiment, step 406 may include receiving, via the web server, an acceptance of at least one of the selling valuation or the buying valuation, and, in step 412, receiving as consideration for the distributed ledger token, via the web server, a cryptocurrency, a second distributed ledger token, or both the cryptocurrency and the second distributed ledger token equal to the buying valuation from at least one buyer resource. According to an embodiment, transferring ownership of the distributed ledger token may further include, in step 414, receiving, via the web server, the distributed ledger token from at least one seller resource, in step 416, transmitting, via the web server, the distributed ledger token to the at least one buyer resource, and, in step 418, transmitting, via the web server, a cryptocurrency, second distributed ledger token, or cryptocurrency and second distributed ledger token transaction equal to the selling valuation to at least one seller resource. Although FIG. 4 illustrates a particular order of steps, it will be acknowledged that some of the steps (e.g., 412 and 414) may be performed in a different order, subject to local regulation. For example, steps 412 can be performed simultaneously or in 414, 412 order. Similarly, the order of steps 416 and 418 can be exchanged or simultaneous.

According to an embodiment, a non-transitory computer readable medium carrying computer instructions capable of causing a computer to execute a method may include the computer method 300, including steps described above with respect to FIG. 3 and one or more of steps 302-316, for conveying value associated with a commodity.

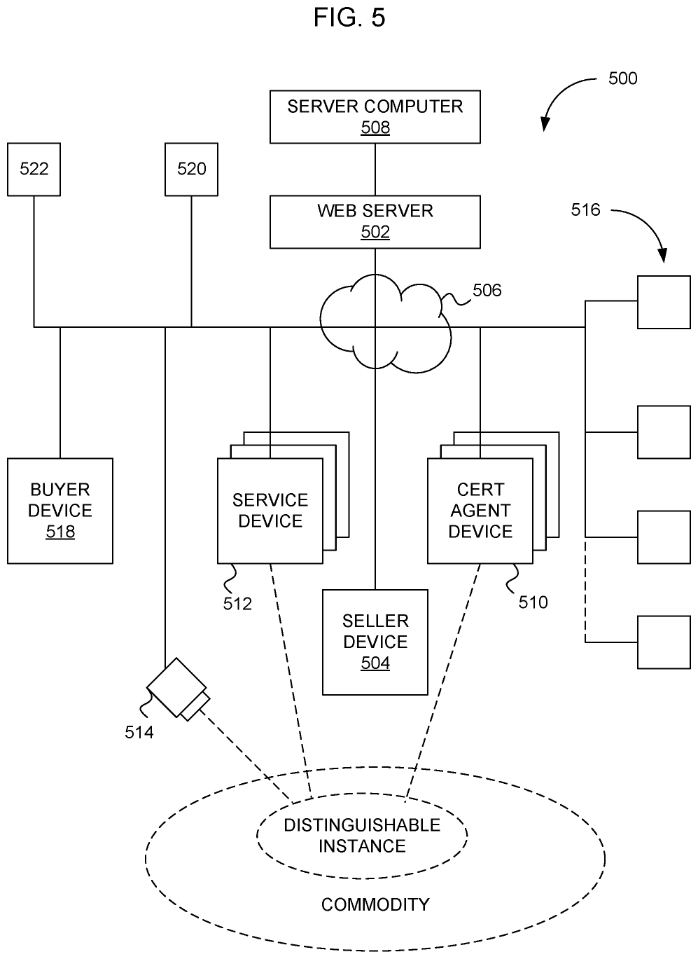

FIG. 5 is a diagram of a computer system 500 for conveying value associated with a commodity, according to an embodiment.

According to an embodiment, the computer system 500 may include a web server 502 operatively coupled to a seller device 504 via a data network, such as the Internet 506. The web server 502 may be configured to receive commodity availability data from the seller device 504, according to an embodiment. The computer system 500 may include at least one server computer 508 operatively coupled to the web server 502, according to an embodiment. The server computer 508 may include one or more processors configured to execute instructions stored on a non-transitory computer readable medium, communication circuitry, and/or one or more graphics processors. The seller device 504 may include a PC, laptop, smart phone, tablet, or other user-accessible computing device capable of receiving and displaying data such as a graphical user interface, receiving user inputs, and transmitting data to the web server 502. The server computer 508 may be configured to receive the commodity availability data from the web server 502, and to issue a distributed ledger token corresponding to a distinguishable instance of the available commodity, according to an embodiment. The server computer 508 may be further configured to credit the distributed ledger token to the seller device 504 in return for a smart contract that causes ownership of the distributed ledger token to represent legal ownership of the commodity distinguishable instance, according to an embodiment. The server computer 508 may be further configured to cooperate with the web server 502 to transmit at least information related to the distributed ledger token and the commodity distinguishable instance represented thereby, via the Internet 506, for display in a graphical user interface (GUI) or the seller device 504, according to an embodiment.

According to an embodiment, in the computer system 500, the server computer 508 may be configured to cooperate with the web server 502 to receive property data related to the commodity distinguishable instance from the seller device 504, and to publish the property data or a pointer thereto onto the distributed ledger token. Additionally or alternatively, the server computer 508 may be configured to cooperate with the web server 502 to receive property data related to the commodity distinguishable instance from a certification agent device 510, and to publish the property data or a pointer to the property data onto the distributed ledger token. In another embodiment, the server computer 508 may be configured to cooperate with the web server 502 to receive location, production, or movement data related to the distinguishable instance of the commodity from a production, transportation, or storage service device 512, and to publish the data or a pointer to the data onto the distributed ledger token. Additionally or alternatively, the server computer 508 may be configured to cooperate with the web server 502 to receive location, production, property, or proof of existence or delivery data from an automated device 514, and to publish the data or a pointer to the data onto the distributed ledger token.

According to an embodiment, the computer method 500 may include a plurality of stakeholder devices 516 operatively coupled to the server computer 508, each stakeholder device 516 holding at least a portion of the distributed ledger. Issuing the distributed ledger token may include transmitting data to at least a portion of the stakeholder devices 516, according to an embodiment.

According to an embodiment, the plurality of stakeholder devices 516 may include the seller device 504 and at least one buyer device 518.

According to an embodiment, the server computer 508 may operate as an oracle configured to add real-world data to the distributed ledger. For example, a server computer 508 operating as an oracle may add data corresponding to a government constraint relevant to a buyer or seller.

According to an embodiment, the computer method 500 may include the buyer device 518 operatively coupled to the web server 502 and the server computer 508. The server computer 508 and the plurality of stakeholder devices 516 may be configured to facilitate a swap of the distributed ledger token from a seller resource 520 (e.g., electronic wallet) to a buyer resource 522 (e.g., electronic wallet).

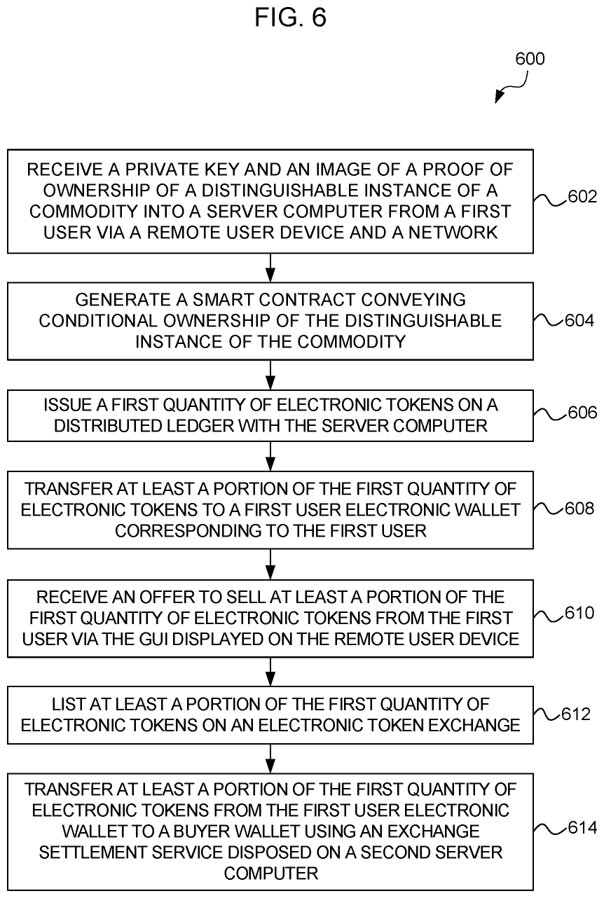

FIG. 6 is a flowchart showing a computer method 600 for transferring an interest in a commodity, according to an embodiment.

According to an embodiment, the computer method 600 for transferring an interest in a commodity includes, in step 602, receiving, through a network into a server computer from a first user via a graphical user interface (GUI) displayed on a remote user device, a private key and an image of a proof of ownership of a distinguishable instance of a commodity. The computer method 600 includes, in step 604, generating a smart contract conveying conditional ownership of the distinguishable instance of the commodity. The computer method 600 includes, in step 606, issuing, with the server computer, a first quantity of electronic tokens on a distributed ledger, the first quantity of electronic tokens carrying the smart contract such that the first quantity of electronic tokens are capable of collectively representing ownership of the distinguishable instance of the commodity. The computer method 600 includes, in step 608, transferring at least a portion of the first quantity of electronic tokens to a first user electronic wallet corresponding to the first user. The computer method 600 includes, in step 610, receiving, from the first user via the GUI displayed on the remote user device, an offer to sell at least a portion of the first quantity of electronic tokens. The computer method 600 includes, in step 612, listing at least a portion of the first quantity of electronic tokens on an electronic token exchange. The computer method 600 includes, in step 614, transferring at least a portion of the first quantity of electronic tokens from the first user electronic wallet to a buyer electronic wallet using an exchange settlement service disposed on a second server computer.

According to an embodiment, the computer method 600 for transferring an interest in a commodity further includes encrypting and storing the proof of ownership at a secret location, and hashing data corresponding to the secret location onto the first quantity of electronic tokens using a distributed ledger transaction. The secret location may include a networked storage address. The networked storage address may be made secret by encrypting the networked storage address before hashing the encrypted storage onto the first quantity of electronic tokens on the distributed ledger.

According to an embodiment, the smart contract condition is satisfied by binding transfer of the distinguishable instance of the commodity to the first quantity of electronic tokens and transfer of at least a portion of the first quantity of electronic tokens to a first user electronic wallet. In an embodiment, the binding transfer of the distinguishable instance of the commodity includes signing the smart contract using the private key.

According to an embodiment, the computer method 600 for transferring an interest in a commodity further includes transmitting a public key to an electronic token exchange. The public key may be configured to enable a buyer to view the proof of ownership without knowing the secret location.

According to an embodiment, in step 610, receiving, from the first user via a remote device, an offer to sell at least a portion of the first quantity of electronic tokens includes establishing an ask price for an electronic token. In one embodiment, establishing an ask price for the electronic token includes receiving an ask price from the first user via a graphical user interface (GUI) on the remote user device and the network.

According to an embodiment, in step 612, the computer method may include listing at least a portion of the first quantity of electronic tokens on the electronic token exchange and, in step 614, transferring at least a portion of the first quantity of electronic tokens from the first user electronic wallet to a buyer electronic wallet using an exchange settlement service disposed on a second server computer.

Step 614 may further include: receiving, through the network, a bid price from the buyer via a buyer device, determining that the ask price and the bid price meet a match criterion, transferring the electronic token to the buyer electronic wallet, and transferring a settlement price to the first user electronic wallet. In one embodiment, the settlement price is denominated in an electronic currency.

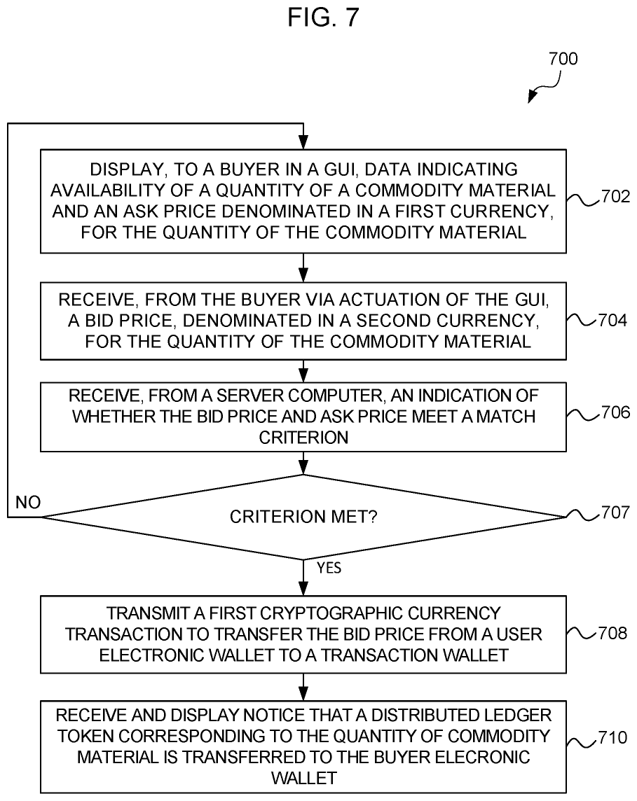

FIG. 7 is a flowchart for a computer method 700 for obtaining rights to a commodity material. According to an embodiment, the computer method includes, in step 702, displaying, to a commodity rights buyer via a first graphical user interface (GUI), data indicating availability of the quantity of a commodity material, and an ask price for the available quantity, denominated in a first currency. Step 704 includes receiving, from the buyer via the GUI, a bid price for the quantity of the commodity material, denominated in a second currency. The computer method 700 may include, in step 706, receiving, from a server computer via the GUI, an indication of whether or not the bid price and the ask price meet a match criterion. According to an embodiment, if the bid price and the ask price are indicated as meeting the match criterion, the computer method may include, in step 708, transmitting to the server computer, a first cryptographic currency transaction to transfer an amount of cryptographic currency corresponding to the bid price from a buyer electronic wallet to a transaction electronic wallet. The computer method further includes, in step 710, receiving notice that a distributed ledger token corresponding to the quantity of the commodity material is transferred to the buyer electronic wallet.

According to an embodiment, for the computer method 700 the first currency may include one or more of United States dollars and a cryptocurrency. The second currency may be a different currency than the first currency, or the second currency may be the same currency as the first currency.

According to an embodiment, the computer method 700 may further include displaying, via the GUI to the buyer, at least one benchmark price for the quantity of the commodity material. According to an embodiment, the computer method 700 may include displaying, via the GUI to the buyer, at least one estimated price for the quantity of the commodity material. According to an embodiment, the computer method 700 may include displaying, via the GUI to the buyer, at least one historical price for the quantity of the commodity material.

According to an embodiment, transmitting the first cryptocurrency transaction from a buyer electronic wallet into a transaction electronic wallet in step 708 may include transferring a fungible cryptocurrency. Alternatively or additionally, transmitting the first cryptocurrency transaction in step 708 may include transmitting a distributed ledger token corresponding to a quantity of a second commodity material different than the commodity material.

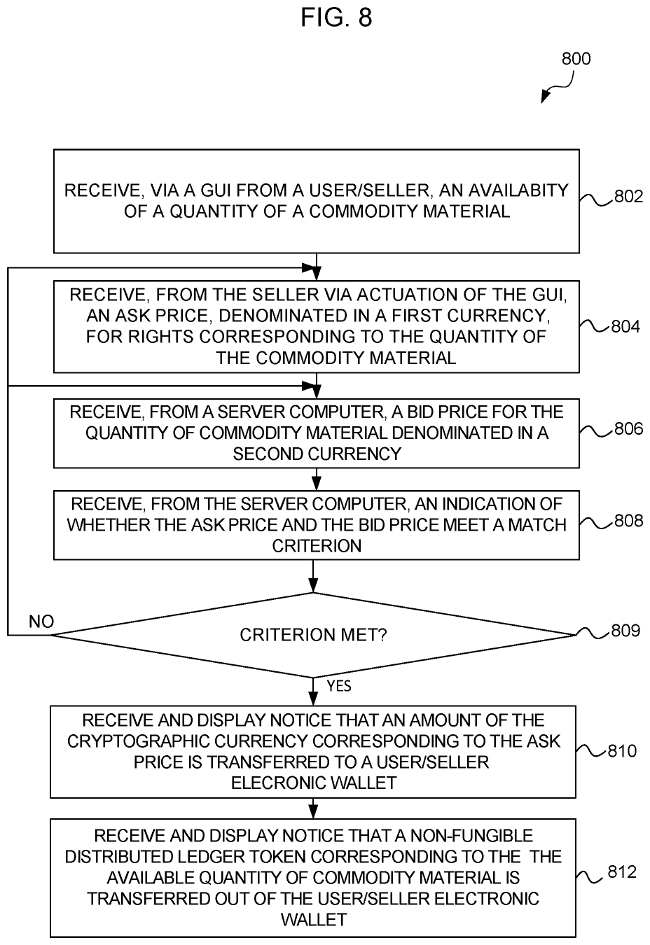

FIG. 8 is a flow chart for a computer method 800 for conveying rights to a commodity material. According to an embodiment, the computer method 800 may include, in step 802, receiving, from a commodity rights seller via a first graphical user interface (GUI), an availability of a quantity of the commodity material. In step 804, the computer method includes receiving, via the first GUI from the seller, an ask price for rights corresponding to the quantity of the commodity material, denominated in a first currency. According to an embodiment, in step 806, the method 800 may include receiving, from a server computer via the GUI, a bid price for the quantity of the commodity material, denominated in a second currency. Step 808 includes receiving, from the server computer via the GUI, an indication of whether or not the bid price and the ask price meet a match criterion. If the bid price and the ask price are indicated as meeting the match criterion, the method 800 may include, step 810, receiving, from a transaction electronic wallet of the server computer to a seller electronic wallet, a first cryptocurrency transaction corresponding to the ask price. The method 800 may further include, in step 812, receiving and displaying a notice that a non-fungible distributed ledger token corresponding to the available quantity of commodity material is transferred out of the seller electronic wallet.

According to an embodiment, the first currency in the computer method 800 may include United States dollars or a first cryptocurrency. The second currency may include a different currency than the first currency, or the second currency by be the same currency as the first currency.

According to an embodiment, the computer method 800 my further include displaying, via the GUI to the seller, at least one benchmark price for the quantity of the commodity material, at least one estimated price for the quantity of the commodity material, and/or at least one historical price for the quantity of the commodity material.

According to an embodiment, the match criterion in step 808 may require the bid price to be greater than or equal to the ask price plus a transaction fee.

According to an embodiment, receiving the first cryptocurrency transaction to the seller electronic wallet, in step 810 may include transferring a fungible cryptocurrency.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

1. A computer method for administering a commodity material transaction, comprising:
receiving, via a first graphical user interface (GUI) from a seller, an ask price for a quantity of a commodity material, denominated in a first currency;
receiving, via a second GUI from a buyer, a bid price for the quantity of the commodity material, denominated in a second currency;
determining that the ask price and the bid price meet a match criterion;
receiving a first cryptocurrency transaction corresponding to the bid price from a buyer electronic wallet into a transaction electronic wallet;
transmitting a second cryptocurrency transaction corresponding to the ask price from the transaction electronic wallet to a seller electronic wallet;
issuing a distributed ledger token corresponding to the quantity of the commodity material; and
transmitting the distributed ledger token to the buyer electronic wallet.

2. The computer method of claim 1, wherein the first currency comprises United States dollars.

3. The computer method of claim 1, wherein the first currency comprises a cryptocurrency.

4. The computer method of claim 1, wherein the second currency comprises a different currency than the first currency.

5. The computer method of claim 1, wherein the second currency comprises the same currency as the first currency.

6-18. (canceled)

19. The computer method of claim 1, wherein the commodity material comprises an in-ground ore or coal.

20-21. (canceled)

22. The computer method of claim 19, wherein the quantity comprises a quantity of refined metal produced from the in-ground ore.

23. The computer method of claim 1, wherein the commodity material is to be produced at a future date.

24. The computer method of claim 1, wherein the commodity material exists in a transportable form at the moment of distributed ledger token issuance.

25. The computer method of claim 1, wherein the commodity material comprises mined ore or coal.

26. The computer method of claim 1, wherein the commodity material comprises natural gas.

27-31. (canceled)

32. The computer method of claim 1, wherein the commodity material comprises an agricultural product.

33. The computer method of claim 1, further comprising:
receiving a second ask price for the distributed ledger token at a later date;
wherein the distributed ledger token represents the same distinguishable instance of the commodity material as when the distributed ledger token was issued.

34. The computer method of claim 1, further comprising:
receiving notice that the distinguishable instance of the commodity material is delivered;
receiving payment for the delivered commodity material; and
redeeming the distributed ledger token for a currency corresponding to the received payment.

35. The computer method of claim 34, wherein the distributed ledger token is burned when redeemed.

36. The computer method of claim 34, wherein the value of the distributed ledger token is reset to zero when redeemed.

37. The computer method of claim 1, wherein the value of the distributed ledger token is set to equal the current value of the quantity of the commodity material.

38. The computer method of claim 37, whereby the distributed ledger token is asset-backed by the distinguishable instance of commodity material it is issued to represent.

39. A non-transitory computer-readable medium carrying computer instructions to cause a computer to execute the computer method of claim 1.

40-42. (canceled)

43. A computer method for conveying value associated with a commodity, comprising:
issuing, with a server computer, a distributed ledger token corresponding to a distinguishable instance of a commodity; and
outputting, with a web server for display via a graphical user interface (GUI) on a user device, information corresponding to the distributed ledger token and the distinguishable instance of the commodity;
wherein the distributed ledger token represents ownership of the distinguishable instance of the commodity.

44-47. (canceled)

48. The computer method for conveying value associated with a commodity of claim 43, wherein issuing the distributed ledger token comprises issuing a public blockchain token.

49. The computer method for conveying value associated with a commodity of claim 43, wherein issuing the distributed ledger token comprises issuing a permissioned blockchain token.

50. The computer method for conveying value associated with a commodity of claim 43, wherein issuing the distributed ledger token comprises issuing a private blockchain token.

51. The computer method for conveying value associated with a commodity of claim 43, wherein issuing the distributed ledger token corresponding to the distinguishable instance of the commodity comprises:
parsing property data related to one or more physical properties of the distinguishable instance of the commodity;
hashing the property data; and
adding the property data onto the distributed ledger as a transaction.

52. The computer method for conveying value associated with a commodity of claim 51, further comprising:
receiving property data from a seller device, the data corresponding to the one or more physical properties.

53-54. (canceled)

55. The computer method for conveying value associated with a commodity of claim 43, wherein issuing the distributed ledger token corresponding to the distinguishable instance of the commodity comprises:
parsing availability data related to a projected date or time of availability of the distinguishable instance of the commodity;
hashing the availability data; and
adding the availability data onto the distributed ledger as a transaction.

56-59. (canceled)

60. The computer method for conveying value associated with a commodity of claim 43, further comprising:
receiving, via the web server, certification data corresponding to a certification of one or more parameters corresponding to the distinguishable instance of the commodity.

61-69. (canceled)

70. The computer method for conveying value associated with a commodity of claim 43, further comprising:
transferring ownership of the distributed ledger token from a seller to a buyer;
wherein transferring ownership of the distributed ledger token also transfers ownership of the distinguishable instance of the commodity corresponding to the distributed ledger token.

71. The computer method for conveying value associated with a commodity of claim 70, wherein transferring ownership of the distributed ledger token comprises:
establishing, using at least the server computer, a selling valuation and a corresponding buying valuation for the distributed ledger token;
receiving, via the web server, an acceptance of at least one of the selling valuation or the buying valuation;
receiving, via the web server, a cryptocurrency, second distributed ledger token, or cryptocurrency and second distributed ledger token transaction equal to the buying valuation from at least one buyer resource;
transmitting, via the web server, the distributed ledger token to the at least one buyer resource; and
transmitting, via the web server, a cryptocurrency, second distributed ledger token, or cryptocurrency and second distributed ledger token transaction equal to the selling valuation to at least one seller resource.

72. A non-transitory computer readable medium carrying computer instructions capable of causing a computer to execute the computer method for conveying a value associated with a commodity of claim 43.

73-81. (canceled)

82. A computer method for transferring an interest in a commodity, comprising:
receiving, into a server computer from a first user via a graphical user interface (GUI) displayed on a remote user device and a network, a private key and an image of a proof of ownership of a distinguishable instance of a commodity;
generating a smart contract conveying conditional ownership of the distinguishable instance of the commodity;
issuing, with the server computer, a first quantity of electronic tokens on a distributed ledger, the first quantity of electronic tokens carrying the smart contract such that the first quantity of electronic tokens are capable of collectively representing ownership of the distinguishable instance of the commodity;
transferring at least a portion of the first quantity of electronic tokens to a first user electronic wallet corresponding to the first user;
receiving, from the first user via the graphical user interface (GUI) displayed on the remote user device, an offer to sell at least a portion of the first quantity of electronic tokens;
listing at least a portion of the first quantity of electronic tokens on an electronic token exchange; and
transferring at least a portion of the first quantity of electronic tokens from the first user electronic wallet to a buyer electronic wallet using an exchange settlement service disposed on a second server computer.

83. The computer method for transferring an interest in a commodity of claim 82, further comprising:
encrypting and storing the proof of ownership at a secret location; and
hashing data corresponding to the secret location onto the first quantity of electronic tokens using a distributed ledger transaction.

84. The computer method for transferring an interest in a commodity of claim 82, wherein the secret location comprises a networked storage address.

85. The computer method for transferring an interest in a commodity of claim 84, wherein the networked storage address is made secret by encrypting the networked storage address before hashing the encrypted storage onto the first quantity of electronic tokens on the distributed ledger.

86. The computer method for transferring an interest in a commodity of claim 82, wherein the smart contract condition is satisfied by binding transfer of the distinguishable instance of the commodity to the first quantity of electronic tokens and transfer of at least a portion of the first quantity of electronic tokens to the first user electronic wallet.

87. The computer method for transferring an interest in a commodity of claim 86, wherein the binding transfer of the distinguishable instance of the commodity includes signing the smart contract using the private key.

88. The computer method for transferring an interest in a commodity of claim 86, further comprising:
transmitting a public key to the electronic token exchange, the public key being configured to enable a buyer to view the proof of ownership without knowing the secret location.

89. The computer method for transferring an interest in a commodity of claim 82, wherein receiving, from the first user via a remote device, an offer to sell at least a portion of the first quantity of electronic tokens includes establishing an ask price for an electronic token.

90. The computer method for transferring an interest in a commodity of claim 89, wherein establishing an ask price for the electronic token includes receiving an ask price from the first user via the GUI displayed on the remote user device and the network.

91. The computer method for transferring an interest in a commodity of claim 82, wherein listing at least a portion of the first quantity of electronic tokens on an electronic token exchange and transferring at least a portion of the first quantity of electronic tokens from the first user electronic wallet to a buyer electronic wallet using an exchange settlement service disposed on a second server computer includes:
receiving a bid price from a buyer via a buyer device and the network;
determining that the ask price and the bid price meet a match criterion;
transferring the electronic token to a second user electronic wallet corresponding to the second user; and
transferring a settlement price to the first user electronic wallet.

92-112. (canceled)
